(19) United States
(12) Patent Application Publication
(10) Pub. No.: US 2024/0240520 A1
(43) Pub. Date: Jul. 18, 2024

(54) WINDOW BLIND CHAIN REEL DEVICE

(71) Applicant: LIN GWO TSAIR ENTERPRISE CO., LTD., Tainan (TW)

(72) Inventor: Yu-Hao LIN, Tainan (TW)

(73) Assignee: LIN GWO TSAIR ENTERPRISE CO., LTD., Tainan (TW)

(21) Appl. No.: 18/539,031

(22) Filed: Dec. 13, 2023

(30) Foreign Application Priority Data
Jan. 16, 2023 (TW) 112200518

(51) Int. Cl. E06B 9/78; E06B 9/42

(52) U.S. Cl. CPC E06B 9/78; E06B 9/42; E06B 2009/785

(57) ABSTRACT

Disclosed is a window blind chain reel device comprising: a housing, a rotating wheel and a driving shaft, wherein the rotating wheel has a circumferential guide groove with a chain winding space being formed between the circumferential guide groove and the housing, and the rotating wheel is formed with a plurality of engaging concaves corresponding to beads of the window blind chain, wherein the window blind chain is arranged to extend into the housing, extend around the rotating wheel along the chain winding space and then extend outward, and thus when the rotating wheel is rotated by the driving shaft, the chain body of the window blind chain is driven, by the engagement between the beads of the window blind chain and the engaging concaves, to move in a manner that one end thereof is retracted inward and the other end thereof is extended outward.

### FIELD OF THE INVENTION

The present invention relates to a window blind chain reel device, and more particularly relates to a window blind chain reel device for a window blind bead chain.

### BACKGROUND OF THE INVENTION

Nowadays, windows for daylighting are often used in offices or home spaces, and, for sake of sunlight blocking and personal privacy, window blinds are widely applied. In addition, the window blinds also have environmental aesthetics, adjusting indoor light, sun protection and heat insulation, maintaining indoor temperature, sound absorption and other uses. The common window blinds are usually controlled by a string or a bead chain.

The string or the bead chain in a conventional vertical window blind generally has a considerable length, or even has its length to the ground in order to correspond to the height of the vertical window blind and operate easier.

Therefore, if the vertical window blind having considerable length is exposed to children, the children may pull the blind string or the blind chain for curiosity to cause dangers such as, strangling or suffocating.

### SUMMARY OF THE INVENTION

Accordingly, one objective of the present invention is to provide a window blind chain reel device to solve technical problems in a prior art.

In order to overcome the technical problems in the prior art, the present invention provides a window blind chain reel device for controlling extension and retraction of a window blind chain, comprising: a housing, having an accommodation space and a chain passage opening on an upper side of the accommodation space; a rotating wheel, which is rotatably disposed in the accommodation space in a manner that an outer peripheral surface of the rotating wheel faces the chain passage opening, wherein a circumferential guide groove is formed around the outer peripheral surface of the rotating wheel such that a chain winding space is formed between the circumferential guide groove and the housing, and the rotating wheel is recessed with a plurality of engaging concaves spaced apart from each other along the circumferential guide groove in a manner that each engaging concaves correspondingly engage with beads of the window blind chain; a driving shaft, which passes through the housing and is fixedly connected to an axle of the rotating wheel to drive the rotating wheel to rotate in the housing, wherein the window blind chain is disposed on the window blind chain reel device by arranging a chain body of the window blind chain to: extend into the accommodation space from the chain passage opening of the housing, extend around the rotating wheel along the chain winding space in a manner that an engagement is correspondingly formed between the beads of the window blind chain and the engaging concaves, and then extend outward through the chain passage opening, and when the rotating wheel is rotated by the driving shaft, the chain body of the window blind chain is driven, by the engagement between the beads of the window blind chain and the engaging concaves, to move such manner that the chain body is retracted toward the accommodation space to extend outward from the accommodation space, thereby performing a window blind operation using the window blind chain.

In one embodiment of the present invention, the window blind chain reel device is provided, wherein a wall surface of the circumferential guide groove is formed as a tapered surface and the circumferential guide groove has a V-shaped profile.

In one embodiment of the present invention, the window blind chain reel device is provided, wherein the engaging concave is formed with a cylindrical space.

In one embodiment of the present invention, the window blind chain reel device is provided, wherein the engaging concave is formed penetrating through a wheel body of the rotating wheel from the tapered surface.

In one embodiment of the present invention, the window blind chain reel device is provided, wherein the driving shaft is connected with a crank for transmitting a rotational driving force from the outside to the driving shaft.

In one embodiment of the present invention, the window blind chain reel device is provided, wherein a rotation radius of the crank is greater than that of the rotating wheel.

In one embodiment of the present invention, the window blind chain reel device is provided, wherein the crank is provided at one end thereof with a crank handle for a user to grasp and input a rotational driving force.

In one embodiment of the present invention, the window blind chain reel device is provided further comprising a chain guide member provided at the chain passage opening, wherein the chain guide member includes two chain guide rail portions parallel to each other and respectively corresponding to the chain winding space, wherein the window blind chain is disposed on the window blind chain reel device by arranging the chain body of the window blind chain to: extend through one of the chain guide rail portions, extend into the accommodation space from the chain passage opening of the housing, extend around the rotating wheel along the chain winding space, and then extend outward through the other of the chain guide rail portions from the chain passage opening.

With the technical means adopted by the present invention, the window blind operation can be performed in a more labor-saving manner by using the window blind chain reel device to control extension and retraction of the window blind chain instead of using a hand to pull the window blind chain. Furthermore, with the technical means adopted by the present invention, the chain guide member for guiding the window blind chain is provided so that the window blind chain is no longer exposed to the outside, thereby enhancing the safety of the operation of the window blind.

### BRIEF DESCRIPTION OF THE DRAWINGS

FIG. 1 is a schematic perspective view illustrating a window blind chain reel device according to one embodiment of the present invention;

FIG. 2 is a schematic exploded view illustrating the window blind chain reel device according to the embodiment of the present invention;

FIG. 3 is a schematic side view illustrating a rotating wheel of the window blind chain reel device according to the embodiment of the present invention;

FIG. 4 is a schematic front view illustrating the window blind chain reel device according to the embodiment of the present invention; and

FIG. 5 is another schematic front view illustrating the window blind chain reel device according to the embodiment of the present invention.

### DETAILED DESCRIPTION OF THE PREFERRED EMBODIMENTS

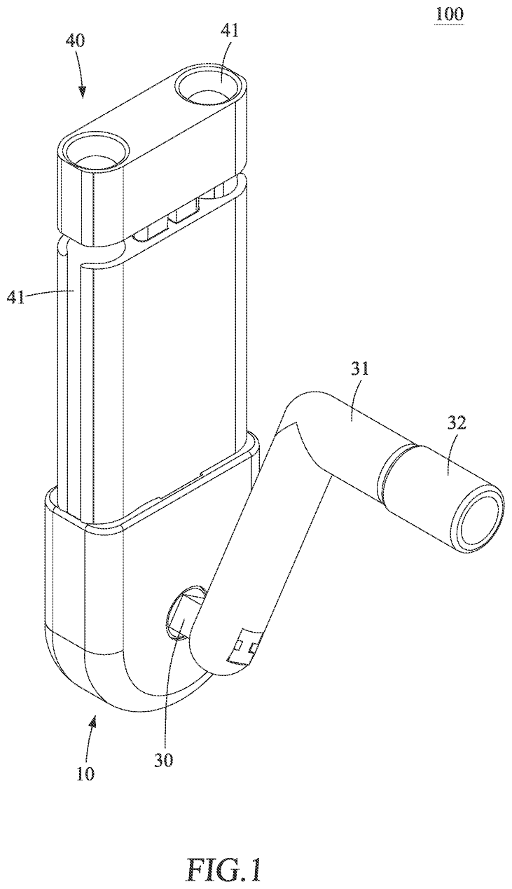

The preferred embodiments of the present invention are described in detail with reference to FIG. 1 to FIG. 5. The description is used for explaining the embodiments of the present invention only, but not for limiting the scope of the claims.

As shown in FIG. 1 to FIG. 5, a window blind chain reel device 100 is provided for controlling extension and retraction of a window blind chain 50, wherein the window blind chain reel device 100 comprises: a housing 10, a rotating wheel 20, a driving shaft 30 and a chain guide member 40.

The housing 10 has an accommodation space 11 and a chain passage opening 12 on an upper side of the accommodation space 11.

The rotating wheel 20 is rotatably disposed in the accommodation space 11 in a manner that an outer peripheral surface of the rotating wheel 20 faces the chain passage opening 12, wherein a circumferential guide groove 21 is formed around the outer peripheral surface of the rotating wheel 20 such that a chain winding space is formed between the circumferential guide groove 21 and the housing 10, and the rotating wheel 20 is recessed with a plurality of engaging concaves 22 spaced apart from each other along the circumferential guide groove 21 in a manner that each engaging concaves 22 correspondingly engage with beads of the window blind chain 50.

In this embodiment, as shown in the drawings, the rotating wheel 20 is in a shape of a disk. Needless to say, the present invention is not limited to this, and the rotating wheel 20 can be in any shape such as hexagonal, octagonal, dodecagonal or hexagonal as long as the rotating wheel 20 is able to rotate in the housing 10.

The driving shaft 30 passes through the housing 10 and is fixedly connected to an axle of the rotating wheel 20 to drive the rotating wheel 20 to rotate in the housing 10.

In the window blind chain reel device 100 according to the embodiment of the present invention, the window blind chain 50 is disposed on the window blind chain reel device 100 by arranging a chain body of the window blind chain 50 to: extend into the accommodation space 11 from the chain passage opening 12 of the housing 10, extend around the rotating wheel 20 along the chain winding space in a manner that an engagement is correspondingly formed between the beads of the window blind chain 50 and the engaging concaves 22, and then extend outward through the chain passage opening 12.

When the rotating wheel 20 is rotated by the driving shaft 30, the chain body of the window blind chain 50 is driven, by the engagement between the beads of the window blind chain 50 and the engaging concaves 22, to move such that the chain body is retracted toward the accommodation space 11 to extend outward from the accommodation space 11, thereby performing a window blind operation using the window blind chain 50.

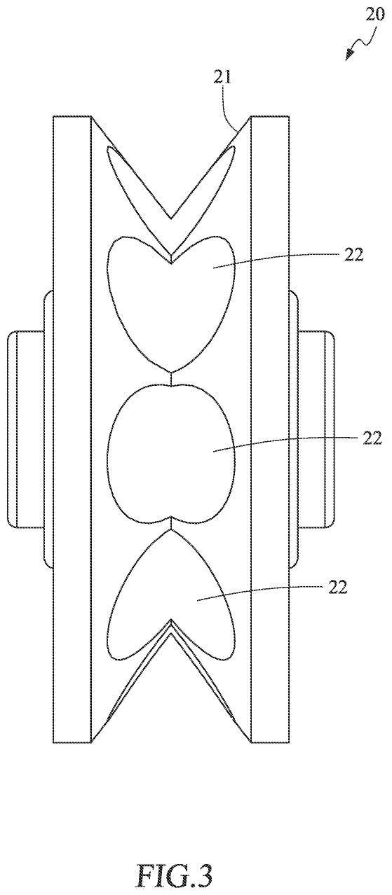

As shown in FIG. 3, in the window blind chain reel device 100 according to the embodiment of the present invention, a wall surface of the circumferential guide groove 21 is formed as a tapered surface and the circumferential guide groove 21 has a V-shaped profile. Needless to say, the present invention is not limited to this, and as long as the chain winding space can be formed between the circumferential guide groove 21 and the housing 1 for the window blind chain 50 to extend around the rotating wheel 20 along the chain winding space, the wall surface of the circumferential guide groove 21 can be a surface of any shape and the circumferential guide groove 21 can have any shape of the profile. For example, the wall surface of the circumferential guide groove 21 maybe formed as a concave circular arc shaped surface, and the circumferential guide groove 21 may have a U-shaped profile.

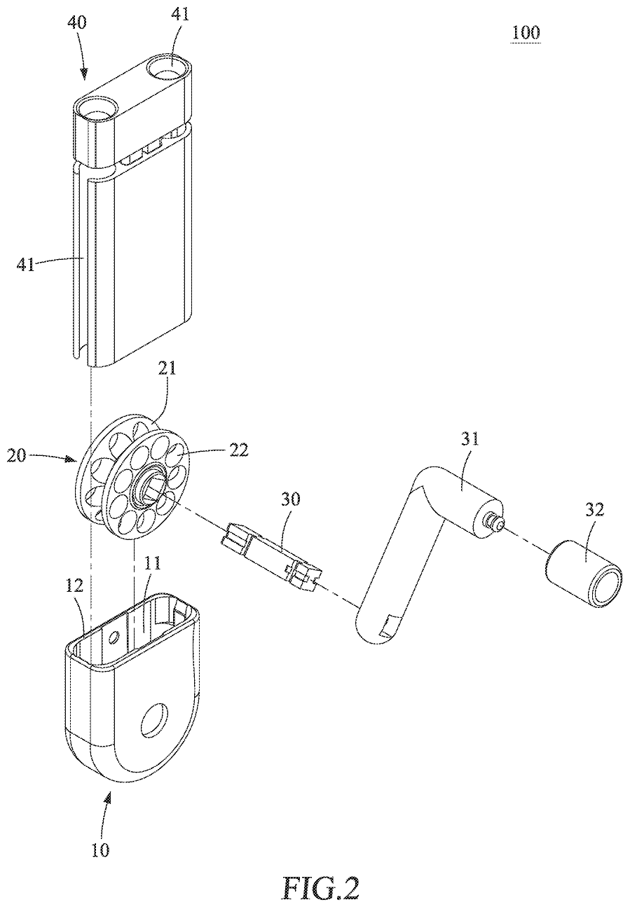

As shown in FIG. 2 and FIG. 3, in the window blind chain reel device 100 according to the embodiment of the present invention, the engaging concave 22 of the rotating wheel 20 is formed with a cylindrical space. With such structure, when the rotating wheel 20 is rotated, the beads of the window blind chain 50 on one side of the circumferential guide groove 21 are successively engaged by the engaging concave 22 while the beads of the window blind chain 50 on the other side of the circumferential guide groove 21 are successively disengaged from the engaging concave 22, thereby driving the window blind chain 50.

As shown in FIG. 2 and FIG. 3, in the window blind chain reel device 100 according to the embodiment of the present invention, the engaging concave 22 of the rotating wheel 20 is formed penetrating through a wheel body of the rotating wheel 20 from the tapered surface. With such structure, the engaging concave 22 can be easily formed in the rotating wheel 20. Needless to say, the present invention is not limited to this, and the engaging concave 22 can be in any shape as long as the engaging concave 22 can be correspondingly engaged with the beads of the window blind chain 50 to allow the window blind chain reel device 100 to drive the window blind chain 50.

As shown in FIG. 1 to FIG. 5, in the window blind chain reel device 100 according to the embodiment of the present invention, the driving shaft 30 is connected with a crank 31 for transmitting a rotational driving force from the outside to the driving shaft 30. In this embodiment, the crank 31 is provided at one end thereof with a crank handle 32 for a user to grasp and input a rotational driving force. Furthermore, a rotation radius of the crank 31 is preferably greater than that of the rotating wheel 20.

With the above structure, the user can input the rotational driving force by grasping the crank handle 32 and rotating the crank 31. The rotational driving force is transmitted to the rotating wheel 20 sequentially through the crank handle 32 and the crank 31, and drives the rotating wheel 20 to rotate in the housing 10. As a result, the chain body of the window blind chain 50 is driven, by the engagement between the beads of the window blind chain and the engaging concaves 22, to move in a manner that one end thereof is retracted toward the accommodation space 11 and the other end thereof is extended outward from the accommodation space 11. Thus, the user can perform the window blind operation in a more labor-saving manner.

As shown in FIG. 1 to FIG. 5, in the window blind chain reel device 100 according to the embodiment of the present invention, the chain guide member 40 is provided at the chain passage opening 12, wherein the chain guide member 40 includes two chain guide rail portions 41 parallel to each other and respectively corresponding to the chain winding space.

The window blind chain 50 is disposed on the window blind chain reel device 100 by arranging the chain body of the window blind chain 50 to: extend through one of the chain guide rail portions 41, extend into the accommodation space 11 from the chain passage opening 12 of the housing 10, extend around the rotating wheel 20 along the chain winding space, and then extend outward through the other of the chain guide rail portions 41 from the chain passage opening 12.

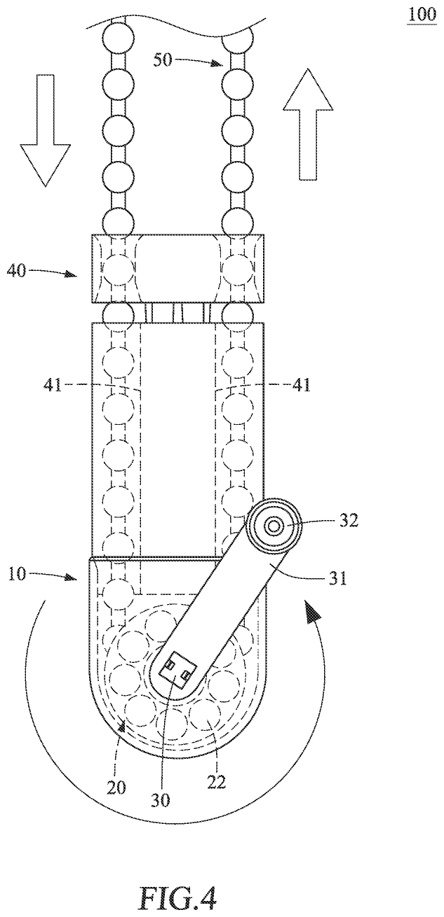

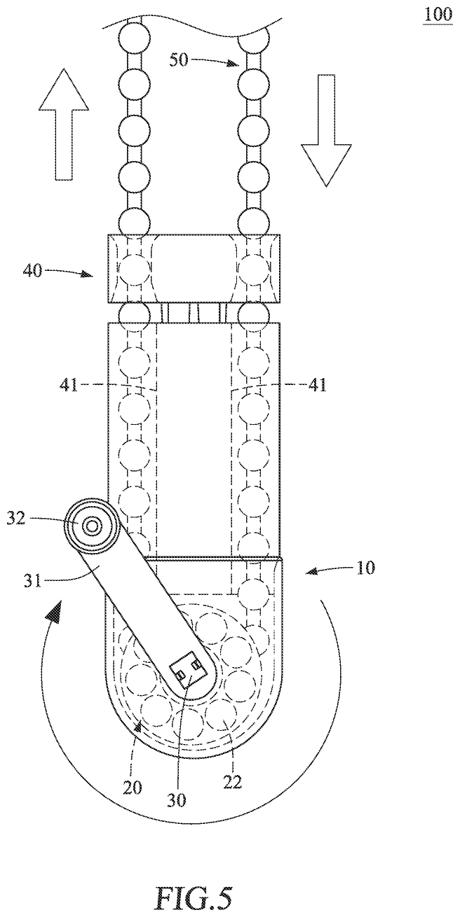

The extension and retraction operation of the window blind chain 50 performed by the window blind chain reel device 100 of the present invention is be described in detail below with reference to FIG. 4 and FIG. 5. In the following, for convenience, directions of the structure of the window blind chain reel device 100 is described based on the up, down, left, right, front and back orientations of the drawings, but the present invention is not limited to this.

FIG. 4 is a schematic front view illustrating the window blind chain reel device according to the embodiment of the present invention, and FIG. 5 is another schematic front view illustrating the window blind chain reel device according to the embodiment of the present invention.

As shown in FIG. 4, when the user performs a counterclockwise rotation operation by grasping the crank handle 32 and rotating the crank 31 to input a rotational driving force of counterclockwise rotation, the rotational driving force of counterclockwise rotation is transmitted to the rotating wheel 20 sequentially through the crank handle 32 and the crank 31, and drives the rotating wheel 20 to rotate counterclockwise in the housing 10.

At this time, the chain body of the window blind chain 50 on the left side extends through the left one of the chain guide rail portions 41, extends into the accommodation space 11 from the left side of the chain passage opening 12 of the housing 10, extends around the rotating wheel 20 along the chain winding space in a manner that the engagement is correspondingly formed between the beads of the window blind chain 50 and the engaging concaves 22 on the left side, the lower side and the right side of the rotating wheel 20, and then extends outward through the right one of the chain guide rail portions 41 from the chain passage opening 12.

In other words, when the user rotates the window blind chain reel device 100 of the present invention in a counterclockwise rotation direction, the window blind chain 50 is driven to be retracted downward on the left side and extended upward on the right side.

Furthermore, as shown in FIG. 5, when the user performs a clockwise rotation operation by grasping the crank handle 32 and rotating the crank 31 to input a rotational driving force of clockwise rotation, the rotational driving force of clockwise rotation is transmitted to the rotating wheel 20 sequentially through the crank handle 32 and the crank 31, and drives the rotating wheel 20 to rotate clockwise in the housing 10.

At this time, the chain body of the window blind chain 50 on the right side extends through the right one of the chain guide rail portions 41, extends into the accommodation space 11 from the right side of the chain passage opening 12 of the housing 10, extends around the rotating wheel 20 along the chain winding space in a manner that the engagement is correspondingly formed between the beads of the window blind chain 50 and the engaging concaves 22 on the right side, the lower side and the left side of the rotating wheel 20, and then extends outward through the left one of the chain guide rail portions 41 from the chain passage opening 12.

In other words, when the user rotates the window blind chain reel device 100 of the present invention in a clockwise rotation direction, the window blind chain 50 is driven to be retracted downward on the right side and extended upward on the left side.

With the window blind chain reel device 100 according to the embodiment of the present invention, the window blind operation can be performed in a more labor-saving manner by using the window blind chain reel device 100 to control extension and retraction of the window blind chain 50 instead of using a hand to pull the window blind chain. Furthermore, with the window blind chain reel device 100 according to the embodiment of the present invention, the chain guide member 40 for guiding the window blind chain 50 is provided so that the window blind chain 50 is no longer exposed to the outside, thereby enhancing the safety of the operation of the window blind.

The above description should be considered as only the discussion of the ordinary skill in the art may make various modifications without deviating from preferred embodiments of the present invention. However, a person having the present invention. Those modifications still fall within the scope of the present invention.

What is claimed is:

1. A window blind chain reel device for controlling extension and retraction of a window blind chain, comprising:
a housing, having an accommodation space and a chain passage opening on an upper side of the accommodation space;
a rotating wheel, which is rotatably disposed in the accommodation space in a manner that an outer peripheral surface of the rotating wheel faces the chain passage opening, wherein a circumferential guide groove is formed around the outer peripheral surface of the rotating wheel such that a chain winding space is formed between the circumferential guide groove and the housing, and the rotating wheel is recessed with a plurality of engaging concaves spaced apart from each other along the circumferential guide groove in a manner that each engaging concaves correspondingly engage with beads of the window blind chain;
a driving shaft, which passes through the housing and is fixedly connected to an axle of the rotating wheel to drive the rotating wheel to rotate in the housing,
wherein the window blind chain is disposed on the window blind chain reel device by arranging a chain body of the window blind chain to: extend into the accommodation space from the chain passage opening of the housing, extend around the rotating wheel along the chain winding space in a manner that an engagement is correspondingly formed between the beads of the window blind chain and the engaging concaves, and then extend outward through the chain passage opening, and
when the rotating wheel is rotated by the driving shaft, the chain body of the window blind chain is driven, by the engagement between the beads of the window blind chain and the engaging concaves, to move such that the chain body is retracted toward the accommodation space to extend outward from the accommodation space, thereby performing a window blind operation using the window blind chain.

2. The window blind chain reel device as claimed in claim 1, wherein a wall surface of the circumferential guide groove is formed as a tapered surface and the circumferential guide groove has a V-shaped profile.

3. The window blind chain reel device as claimed in claim 1, wherein the engaging concave is formed with a cylindrical space.

4. The window blind chain reel device as claimed in claim 2, wherein the engaging concave is formed penetrating through a wheel body of the rotating wheel from the tapered surface.

5. The window blind chain reel device as claimed in claim 1, wherein the driving shaft is connected with a crank for transmitting a rotational driving force from the outside to the driving shaft.

6. The window blind chain reel device as claimed in claim 5, wherein a rotation radius of the crank is greater than that of the rotating wheel.

7. The window blind chain reel device as claimed in claim 1, wherein the crank is provided at one end thereof with a crank handle for a user to grasp and input a rotational driving force.

8. The window blind chain reel device as claimed in claim 1, further comprising a chain guide member provided at the chain passage opening, wherein the chain guide member includes two chain guide rail portions parallel to each other and respectively corresponding to the chain winding space,
wherein the window blind chain is disposed on the window blind chain reel device by arranging the chain body of the window blind chain to: extend through one of the chain guide rail portions, extend into the accommodation space from the chain passage opening of the housing, extend around the rotating wheel along the chain winding space, and then extend outward through the other of the chain guide rail portions from the chain passage opening.
